(19) United States
(12) Patent Application Publication
(10) Pub. No.: US 2007/0088664 A1
(43) Pub. Date: Apr. 19, 2007

(54) Mobile medication history management apparatus, memory card, and management method

(76) Inventors: Toshihisa Nakano, Osaka (JP); Kaoru Yokota, Hyogo (JP); Motoji Ohmori, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/577,041

(22) PCT Filed: Dec. 8, 2004
(86) PCT No.: PCT/JP04/18674

§ 371 Date: Apr. 24, 2006

(30) Foreign Application Priority Data
Dec. 9, 2003 (JP) 2003-410783

(51) Int. Cl. G06F 15/00

(52) U.S. Cl. 706/10

(57) ABSTRACT

A medication history management apparatus enables a person to check for side-effects caused by combinations of drugs, and duplicated administration of drugs, when purchasing non-prescription drugs, even without medical knowledge. The medical history management apparatus securely stores medication history information identifying drugs taken in the past and drugs prescribed in the past in a secure storage unit 403, and stores mutual effect information that shows side-effects caused by combinations of drugs. The medical history management apparatus receives input information identifying a drug from a keypad, judges whether the set of the input information and the any of the drug history information match the any of the mutual effect information, and outputs a judgment result.

### TECHNICAL FIELD

The present invention is a mobile medication history management apparatus that manages medication history, and, in particular, relates to judgment of physical effects caused by combinations of drugs.

### BACKGROUND ART

Conventionally, a patient who visits a medical institution for an injury or an illness goes to a pharmacy to purchase a drug prescribed by a doctor at the medical institution after being examined by the doctor.

However, if the patient visits a different medical institution in the future for examination for another injury or illness, the patient will receive a prescription separately to the one received at the previous medical institution. In such a case, it is difficult for the patient to know of and physical effects caused by a combination of the two drugs, such as physical effects due to a drug being administered in duplicate, or mutual effects.

The following briefly describes a medication history management system proposed to solve this problem.

In the proposed medication history management system, the prescription history of individual patients is managed overall by management means, and a card for authentication is issued to each individual patient.

When a doctor needs to refer to the prescription history of a particular patient, the card is read by a card terminal, and an authentication process is performed. When authentication succeeds, the doctor is able to access the prescription history in the management means to add information, read information, and so on.

The doctor is able to refer to the prescription history to check for duplicate administration and mutual effects only when he/she borrows a legitimate card temporarily from the patient.

However, this system does not enable the patient to know of physical effect caused by a combination of drugs.

As one example, a problem occurs with this system when the patient purchases non-prescription cold medication or the like at a retail establishment. Since a patient is unable to access his/her prescription history, and usually does not have knowledge of mutual effects, the patient is unable to judge whether the cold medication is the same as the prescription drug being taken, and also unable to judge whether a mutual effect will be caused by the combination of the cold medication and the prescription drug.

As a result, the patient may take a same drug in duplicate, or take a drug that will cause a mutual effect with the drug presently being taken, and consequently experience an adverse physical effect.

### DISCLOSURE OF THE INVENTION

In view of the described problems, the object of the present invention is to provide a mobile medication history management apparatus that enables an individual patient to determine physical effects caused by factors such as mutual effects of drugs and duplicate administration of drugs.

In order to solve the described problems, the present invention is a mobile medication history management apparatus, including: an obtaining unit operable to obtain identification information relating to a drug that a user of the medication history management apparatus is planning to take; a secure storage unit operable to store, in a secure storage area therein, medication history information of a drug that the user has taken previously; an information storage unit operable to store mutual effect information showing one or more mutual effects, each mutual effect being caused by taking of drugs in combination; a judgment unit operable to refer to the stored mutual effect information to check whether any combinations exist therein of the drug shown by the obtained identification information and any of the previously taken drugs estimated to have a remaining physical effect in the user, in order to judge whether a mutual effect will occur due to taking the drug show by the obtained identification information and any of the previously taken drugs; and an output unit operable to output a judgment result.

According to the stated structure, the mobile medication history management apparatus is able to make an output regarding a physical effect of the combination of a drug that the user is planning to take, and a drug that has already been taken and whose effects are estimated to remain in the user. Therefore, the user is able to know about the physical effects, and is able to avoid taking medicine that will cause a physical effect in combination with another drug already taken.

Here, each of the drug that the user is planning to take and the one or more previously taken drugs may be a one of a prescription drug and non-prescription drug.

According to the stated structure, regardless of whether the drug that the patient is planning to take and the drug that the patient has already taken are prescription drugs, non-prescription drugs, or a combination of both, the mobile medication history management apparatus is able to make an output regarding physical effects caused by taking the planned drug in combination with the taken drug whose effects are assumed to remain. Therefore, the user is able to know of the physical effects in advance, and avoid taking prescription and non-prescription medicine that have a physical effect due to being taken in combination.

Here, the mobile medication history management apparatus may further include: a first download unit operable to download mutual effect information from an external server, and store the mutual effect information in the information storage unit.

According to the stated structure, the mobile medication history management apparatus downloads and stores the mutual effect information from an external server, and therefore is able to judge for physical effects based on the latest mutual effect information.

Here, the mobile medication history management apparatus may further include: a second download unit operable to download medication history information from a server that is one of a hospital server and a pharmacy server, and store the medication history information in the secure storage unit.

According to the stated structure, the mobile medication history management apparatus securely downloads and stores the medication history information from the hospital server or the pharmacy server, and therefore medication history information held by an external server can be obtained.

Here, when the second download unit downloads the medication history information, the second download unit and the server may perform mutual authentication processing, writing of the downloaded medication history information to the secure storage unit being permitted only when authentication succeeds.

According to the stated structure, the mobile medication history management apparatus, when downloading, executes authentication processing, and permits writing to the secure storage unit when authentication succeeds. Therefore, writing to the secure storage unit can be restricted to legal servers.

Here, the mobile medication history management apparatus may further include: a timer operable to count time from when each of the one or more previously taken drugs is taken; and an effect time storage unit operable to store a physical effect remain time of each of one or more drugs, each physical effect remain time showing a length of time that the physical effect of the drug remains in the user from when the drug is taken, wherein, when making the judgment, if the counted time of a previously taken drug in combination with the planned drug in the medication history information is less than the physical effect remain time of the previously taken drug, the judgment unit selects drug identification information of the previously taken drug as a target of comparison, and if the counted time of a previously taken drug in combination with the planned drug exceeds the physical effect remain time of the previously taken drug, the judgment unit excludes the drug identification information of the previously taken drug from being a target of comparison.

According to the stated structure, the mobile medication history management apparatus uses the timer to measure time that has elapsed since the patient took a drug, and judges whether or not the measured time exceeds the effect remain time. Only drugs for which the measured time does not exceed the effect remain time are a comparison target. Therefore, the user is able to know physical effects only of drugs whose effects remain

Here, the mobile medication history management apparatus may further include: a completion reception unit operable to receive, from an external source, information showing that the user has taken the planned drug; and a write unit operable to write the received information additionally in the drug identification information stored in the secure storage unit.

According to the stated structure, the mobile medication history management apparatus is able to add information about a drug that has been taken to the secure storage unit. Therefore, medication history of drugs that have been taken can be managed securely.

Here, the completion reception unit and the timer of the judgment unit may operate in synchronization such that the timer commences counting time upon receiving a completion signal.

According to the stated structure, the mobile medication history management apparatus can start timing as soon as the completion signal is received. Therefore, the mobile medication history management apparatus is able to know accurately the time elapsed since receiving the completion signal, and the user is saved the effort of having to instruct the mobile medication history apparatus to start counting time.

Here, the mobile medication history management apparatus may be a mobile telephone that is equipped with a secure memory card, wherein the completion signal is transmitted to the memory card upon a specific key of the mobile telephone being pressed.

According to the stated structure, the completion signal is transmitted to the memory card upon the specific key being pressed. Therefore, the user is able to notify the mobile medication history management apparatus that a drug has been taken when he/she wishes to do so.

Here, the mobile medication history management apparatus may be a mobile terminal that is equipped with a secure memory card.

According to the stated structure, the mobile medication history management apparatus can be composed of a mobile terminal that is equipped with a secure memory card.

Here, the mobile terminal may be a mobile telephone.

According to the stated structure, the mobile medication history management apparatus can be composed of a mobile telephone that is equipped with a secure memory card.

Here, the memory card may be detachably mounted in the mobile terminal.

According to the stated structure the secure memory card can be detached from the mobile terminal.

Furthermore, the present invention is a memory card that is used in an inserted state in a memory card slot of a mobile terminal, including: an obtaining unit operable to obtain, from the mobile terminal, identification information relating to a drug that a user of the mobile terminal is planning to take; a secure storage unit operable to store, in a secure storage area therein, medication history information of a drug that the user has taken previously; an information storage unit operable to store mutual effect information showing one or more mutual effects, each mutual effect being caused by taking of drugs in combination; a judgment unit operable to refer to the stored mutual effect information to check whether any combinations exist therein of the drug shown by the obtained identification information and any of the previously taken drugs estimated to have a remaining physical effect in the user, in order to judge whether a mutual effect will occur due to taking the drug show by the obtained identification information and any of the previously taken drugs; and an output unit operable to output a judgment result to the mobile terminal.

According to the stated structure, the memory card is able to make an output regarding a physical effect of the combination of a drug that the user is planning to take, and a drug that has already been taken and whose effects are estimated to remain in the user. Therefore, the user is able to know about the physical effects, and is able to avoid taking medicine that will cause a physical effect in combination with another drug already taken.

Furthermore, in order to achieve the stated object, the present invention is a management method executed in a mobile medication history management apparatus that includes a secure storage unit that stores, in a secure storage area therein, medication history information of one or more drugs that a user of the medication history management apparatus has taken previously, and an information storage unit that stores information showing one or more mutual effects, each mutual effect being caused by taking drugs in combination, the management method including: an obtaining step of obtaining identification information relating to a drug that the user is planning to take; a reading step of reading the medication history information from the secure storage unit; a judgment step of referring to the stored mutual effect information to check whether any combinations exist therein of the drug shown by the obtained identification information and any of the previously taken drugs estimated to have a remaining physical effect in the user, in order to judge whether a mutual effect will occur due to taking the drug shown by the obtained identification information and any of the previously taken drugs; and an output step of outputting a judgment result.

According to the stated structure, the mobile medication management apparatus is able to make an output regarding a physical effect of the combination of a drug that the user is planning to take, and a drug that has already been taken and whose effects are estimated to remain in the user. Therefore, the user is able to know about the physical effects, and is able to avoid taking medicine that will cause a physical effect in combination with another drug already taken.

Here, the management method may further include: a first download step of obtaining mutual effect information from an external server, and storing the mutual effect information in the information storage unit, the first download step being performed in a routine that is separate to a processing sequence that includes the obtaining step though to the output step.

According to the stated structure, the mobile medication history management apparatus downloads and stores the mutual effect information from an external server, and therefore is able to judge for physical effects based on the latest mutual effect information.

Here, the management method may further include: a second download step of downloading medication history information from a server that is one of a hospital server and a pharmacy server, and updating contents of the secure storage unit with the downloaded medication history information, the second download step being performed in a routine that is separate from the processing sequence.

According to the stated structure, the mobile medication history management apparatus securely downloads and stores the medication history information from the hospital server or the pharmacy server, and therefore medication history information held by an external server can be obtained.

Furthermore, the second download step may include: an authentication sub-step of, when downloading, executing an authentication sequence with the server, access to the secure storage unit being permitted only when authentication succeeds.

According to the stated structure, the mobile medication history management apparatus, when downloading, executes authentication processing, and permits writing to the secure storage unit when authentication succeeds. Therefore, writing to the secure storage unit can be restricted to legal servers.

### BRIEF DESCRIPTION OF THE DRAWINGS

FIG. 1 is a block diagram showing the structure of a medication history management system of the present invention;

FIG. 2 shows a mutual effect table that shows mutual effects of drugs sold by a pharmaceutical company, and that is provided by the pharmaceutical company;

FIG. 3 is prescription information that is a collection of prescription data, and that is held by a memory card;

FIG. 4 is a block diagram showing the internal structure of a mobile terminal and a memory card;

FIG. 5 shows an example of a non-prescription medication history table stored in a secure storage unit;

FIG. 6 is an example of a check-target selection screen;

FIG. 7 is a schematic drawing of the structure of a skin diagnosis system;

FIG. 8 shows a moisture amount judgment table stored by a memory card;

FIG. 9 shows a skin level table stored by the memory card;

FIG. 10 shows a skin condition history table; and

FIG. 11 is a block diagram showing the internal structure of a mobile terminal and a memory card.

### BEST MODE FOR CARRYING OUT THE INVENTION

The following describes embodiments the present invention, with use of the drawings.

### First Embodiment

1. Medication History Management System

1.1 Outline

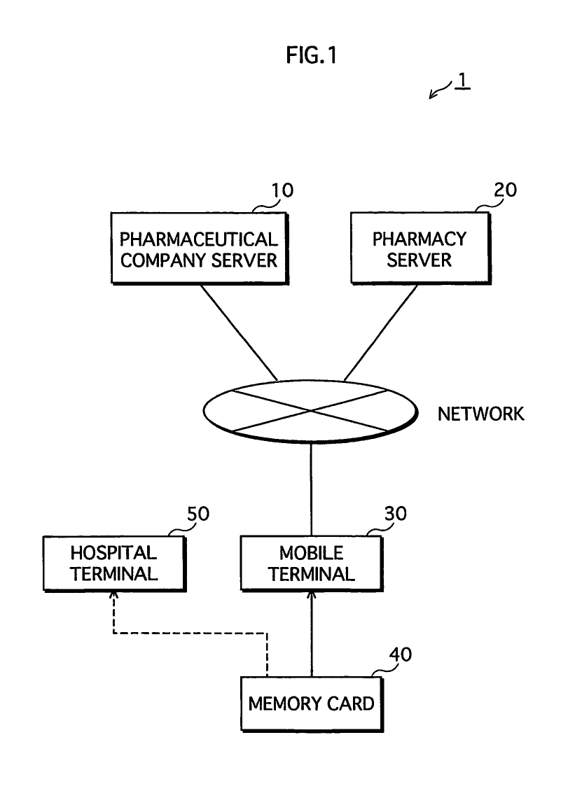

FIG. 1 is a block drawing showing the structure of a medication history management system 1.

A pharmaceutical company server 10 is operated by a pharmaceutical company that manufactures and sells drugs. The pharmaceutical company server 10 provides information relating to mutual effects of drugs that the pharmaceutical company sells.

Mutual effects refers to effects that occur unforeseen by a person who takes a plurality of drugs within a predetermined time period, and that are preferably avoided due to adverse effects on health. Such mutual effects include the effect of one or both drugs being cancelled out or increased.

Mutual effects are not limited to effects that occur when a plurality of drugs are administered, but also include effects that occur due to consuming a combination of a particular drug and a particular food, such as grapefruit.

For brevity, in the present embodiment each drug and food relating to a mutual effect is given an item identification number which uniquely identifies the drug or food. As one example, a drug whose name is “acetohexamide” is given a value “1” as an item identification number, a drug whose name is “insulin preparation” is given a value “25” as an item identification number, and the fruit “grapefruit” is given a value “8000” as an item identification number. These values enable each item to be uniquely identified.

Furthermore, symptoms that occur due to a mutual effect are each given a unique symptom identification number. As one example, a symptom identification number value “1” indicates a symptom “increase of insulin in the blood”.

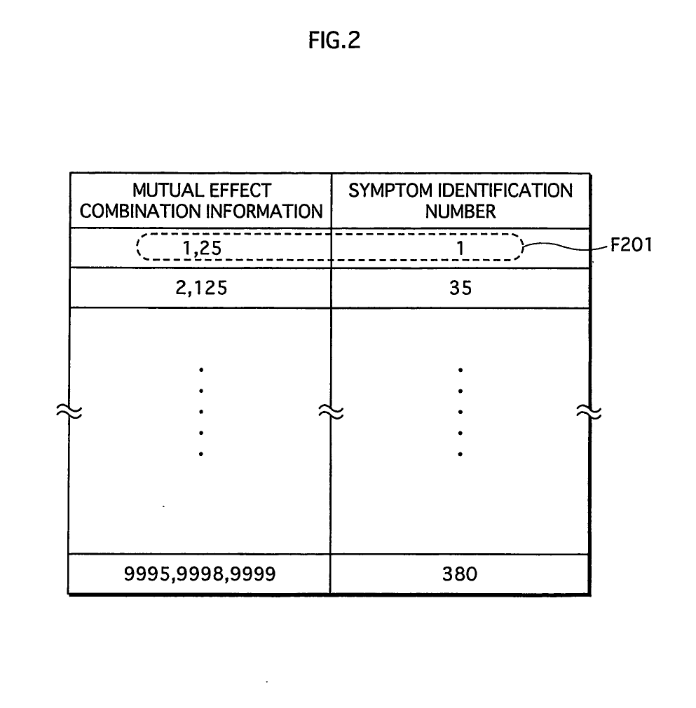

FIG. 2 shows a mutual effect table that is provided by the pharmaceutical company server 10, and shows to mutual effects of drugs sold by the pharmaceutical company.

Each piece of mutual effect combination information is a set of item ID numbers of a set of drugs or a set of a drug and food that cause a mutual effect.

In FIG. 2, a frame F201 shows that “acetohexamide”, which is identified by an item identification number of the value “1”, and “insulin preparation”, which is identified by an item identification number “25”, have a mutual effect that causes the symptom “increase of insulin in the blood”, which is identified by the symptom identification number of the value “1”.

The pharmacy server 20 is operated by a pharmacy where a patient who uses the medication history management system 1 ordinarily purchases drugs based on prescriptions issued at a hospital.

The pharmaceutical company server 10 and the pharmacy server 20 are connected via a network.

The patient carries a mobile terminal 30 in which a memory card 40 is inserted. The memory card 40 includes an IC and a secure storage area, and has a function of judging whether a mutual effect will occur.

Take, for example, a case in which the patient is considering purchasing non-prescription cold medication at a convenience store or the like. The patient uses a keypad of the mobile terminal 30 to input information for judging whether or not a mutual effect will occur with medicine currently being prescribed by the doctor, and obtains a judgment result showing whether a mutual effect will occur.

The mobile terminal 30 has a wireless communication function, and connects to the network via a wireless relay station (not illustrated).

The mobile terminal 30 downloads the mutual effect table provided by the pharmaceutical company server 10, and stores the down loaded table in the memory card 40. Note that the mobile terminal 30 may be set to newly download the mutual effect table at regular time intervals, or may be set to receive an update notification from the pharmacy server 10 each time the mutual effect table is been updated.

The judgment by the memory card 40 of whether a mutual effect will occur is described in detail later.

A hospital terminal 50 is located at the patient's usual hospital.

After being examined at the hospital, the patient presents the memory card 40 to the doctor at the hospital, and the doctor inserts the memory card 40 in the hospital terminal 50.

The doctor issues a prescription to the patient, and writes prescription information to the memory card 40 using the hospital terminal 50. Here, the prescription information is digitized data of the prescription.

The prescription data includes “prescription date” on which the prescription was issued, a “prescription days” indicating how many days' worth of drugs are prescribed, and “prescription drug number” that is an item identification number identifying the prescribed drug.

If the doctor prescribes the drug “acetohexamide”, for example, the prescribed drug number will be “1”, which is the value of the item identification number of the drug “acetohexamide”.

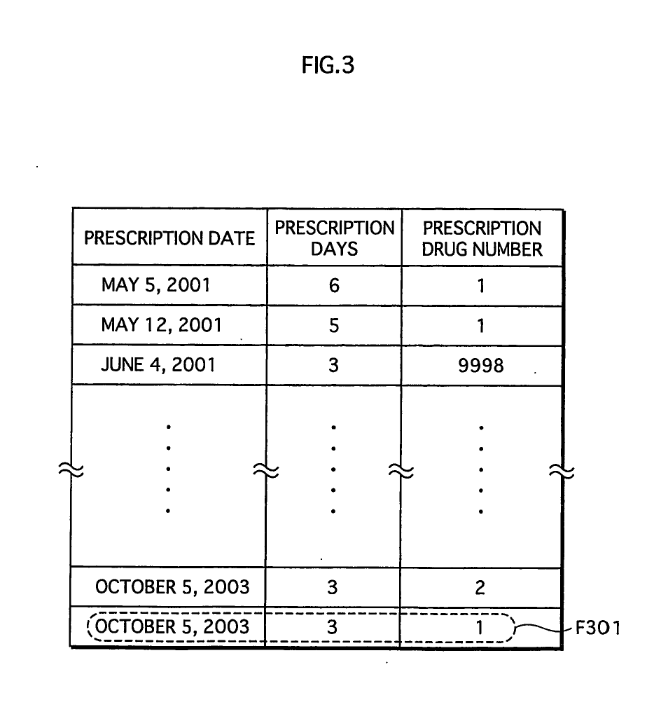

FIG. 3 is prescription information which is stored in the memory card 40, and is a collection of pieces of prescription data.

The pieces of prescription data are stored in the prescription information in order of prescription date, from earliest to latest prescription date. When the storage capacity of the memory card 40 is full, the memory card 40 destroys the earliest piece of prescription data.

A frame F301 shows a piece of prescription data in which the prescription date is Oct. 5, 2003, the prescription days is “3”, and the prescription drug number is “1”.

The patient receives the memory card 40 back from the doctor, and inserts the memory card 40 in the mobile terminal 30.

The patient must go to the pharmacy to purchase the drug prescribed by the doctor. However, the patient may be forced to wait a considerable amount of time at the pharmacy to make the purchase. For this reason, the patient checks first checks when he/she should go to the pharmacy.

The memory card 40 transmits prescription data corresponding to the drug that is as yet un-purchased to the pharmacy server 20 via the mobile terminal 30.

The pharmacy server 20 receives the prescription information, and, if the drug identified by the prescription drug number in the prescription data is in stock at the pharmacy, transmits visit information indicating when the patient should come to the pharmacy, to the mobile terminal 30.

If the drug is not in stock at the pharmacy, the pharmacy server 20 generates visit information based on a predetermined amount of days from ordering the drug thorough to when to drug will arrive at the pharmacy, and transmits the visit information to the mobile terminal 30.

The visit information indicates a date and time, such as “15:30, Oct. 5, 2003”.

When the drug is not in stock, the pharmacy server 20 orders a predetermined amount of the drug from a predetermined supplier, via the network.

The patient knows from the visit information that he/she will be able to receive the drug without waiting if he/she goes to the pharmacy at the date and time indicated by the visit information.

1.2 Structure

1.2.1 Pharmaceutical Company Server 10

The pharmaceutical company server 10 is, specifically, a computer system that includes a microprocessor, a ROM (read only memory), a RAM (random access memory), a display unit, a keyboard, a hard disk, and the like. Computer programs are loaded into the RAM, and the pharmaceutical company server 10 achieves its functions by the microprocessor operating according to the computer programs.

The pharmaceutical company server 10 stores the mutual effect table in the hard disk.

The mutual effect table is updated by maintenance personnel at the pharmaceutical company as appropriate. Cases in which the mutual effect table requires updating include when the formula of a drug is changed, when a new drug is added, and when a new mutual effect is discovered. When the mutual effect table has been updated, the pharmaceutical company server 10 transmits a mutual effect table update instruction that includes the mutual effect table, to the terminal 30.

1.2.2 Pharmacy Server 20

The pharmacy server 20 is, specifically, a computer system that includes a microprocessor, a ROM, a RAM, a display unit, a keyboard, a hard disk, and the like. Computer programs are loaded into the RAM, and the pharmacy server 20 achieves its functions by the microprocessor operating according to the computer programs.

In order to detect illegitimate requests for purchase of drugs, the pharmacy server 20 authenticates the inquiring party.

The pharmacy server 20 shares a pharmacy shared key in advance with the memory card 40. Furthermore, the pharmacy server 20 stores a pharmacy card ID and a corresponding pharmacy password, in order to identify the memory card 40.

A pharmacist working at the pharmacy where the pharmacy server 20 is located uses the keyboard to input a “work wait time” that indicates how much time will be required to commence work on preparing a drug from when a request is received, taking into consideration factors such as how crowded the pharmacy is. The work wait time is updated regularly.

The pharmacy server 20 stores, in advance, preparation time information indicating how much time is required to prepare each drug. Furthermore, the pharmacy server 20 stores, for each drug, a “day counts” indicating how many days are required from ordering to receiving the drug.

The pharmacy server 20 receives the prescription data, and transmits visit information corresponding to the prescription data to the mobile terminal 30.

The pharmacy server 20 receives a card authentication request from the mobile terminal 30. The card authentication request is a request to authenticate the memory card 40, and includes a card ID that identifies the memory card, and a password that has been encrypted with the pharmacy shared key.

The pharmacy server 20 judges whether the set of the received card ID and encrypted password matches the set of the pre-stored pharmacy card ID and pharmacy password. The pharmacy server 20 transmits a card authentication result showing normal authentication when the two sets match, and transmits a card authentication result showing abnormal authentication when the two sets do not match.

When authentication with the mobile terminal 30 has succeeded, the pharmacy server 20 receives encrypted prescription data from the mobile terminal 30, and decrypts the encrypted prescription data using the pharmacy shared key. The encrypted prescription data is for requesting preparation of a drug, and so on.

After receiving the prescription data, the pharmacy server 20 transmits “visit time-date information” to the mobile terminal 30. The visit time-date information is a time and date obtained by adding, to the time and date of reception of the prescription data, the time indicated by the work wait time information, and the time indicated by preparation time information of the drug identified by the item identification number in the prescription data.

Note that when the drug indicated by the prescription data is not in stock at the pharmacy, the pharmacy server 20 instead adds the predetermined number of days required from ordering the drug thorough to when to drug will arrive at the pharmacy to the time and date of reception of the prescription data, and transmits the resulting time and date to the mobile terminal 30 as visit information.

The pharmacy server 20 performs display so as to alert the pharmacist to prepare the drug indicated by the prescription data.

1.2.3 Mobile Terminal 30

The mobile terminal 30 is, specifically, a PDA (personal digital assistant) or the like that includes a ROM, a RAM, a display, and a keyboard. The mobile terminal 30 achieves its functions by the microprocessor operating according to computer programs that are loaded into the RAM.

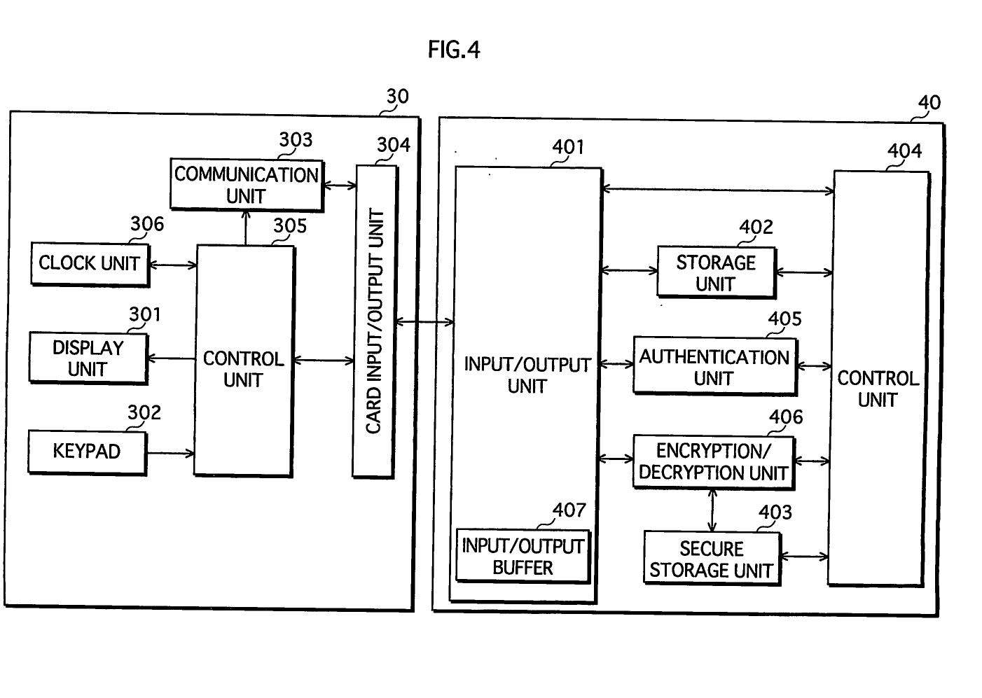

FIG. 4 is a block diagram showing the internal structure of the mobile terminal 30 and the memory card 40.

The display unit 301 is a liquid crystal display, and displays according to instructions by the control unit 305.

The keypad 302 has input button including a ten keypad, and is used by the patient to give various instructions to the mobile terminal 30. The keypad 302 transmits key information corresponding to a pressed key to the control unit 305.

The communication unit 303 connects to the network by wireless communication via the wireless relay station (not illustrated) and the like, and communicates with the pharmaceutical company server 10 and the pharmacy server 20.

The card input/output unit 304 connects with an input/output unit 401, and has the functions of transmitting data to and from the memory card 40 and supplying power to the memory card 40.

The clock unit 306 is a clock that has a timer and a calendar, and writes time-date information expressing a counted time to an internal time-date register. One example of the time-date information that the clock unit 306 writes to the time-date register is time-date information expressing “13:20, Oct. 5, 2003”. The clock unit 306 also has the function of giving timer notification to the control unit 305 once an hour.

On receiving timer notification from the clock unit 306, the control unit 305 reads the time-date information from the time-date register of the clock unit 306, and transmits time-date information notification that includes the time-date information to the memory card 40 via the card input/output unit 304.

The control unit 305 stores, in advance, a correspondence table of names of drugs sold in pharmacies and the like, and item identification numbers.

The control unit 305 receives “selling wait time information” from the memory card 305, and instructs the display unit 301 to display the received selling wait time information.

The control unit 305 receives various key information from the keypad 302, and performs processing corresponding to the received key information.

1.2.4 Memory Card 40

The memory card 40 is a portable memory card that includes a microprocessor, a ROM, a RAM, and a memory that has a secure area.

The memory card 40 operates according to power supplied by the mobile terminal 30. Note that an alternative structure is one in which the memory card 40 has an internal battery, and therefore does not require power from the mobile terminal 30.

The input/output unit 401 transmits data to receives data from the card input/output unit 304. The input/output unit 401 temporarily stores received data and data to be transmitted in the input/output buffer 407.

The transmitted and received data has a header in which is written information necessary in transmission and reception. This information includes the data type, data transmission-origin data, and data transmission-destination information.

In the case of receiving data, the input/output unit 401 stores the received data in the input/output buffer 407, and transmits data reception notification to the control unit 404. The control unit 404 checks the header of the reception data stored in the input/output buffer 407, and sorts the stored data to the storage unit 402, the control unit 404, the authentication unit 405, and the encryption/decryption unit 406.

In the case of being instructed to transmit data, the input/output unit 401 transmits the data to the card input/output unit 304 in accordance with the instruction.

The storage unit 402 includes a storage area, and, according to an instruction by the control unit 404, receives and stores the mutual effect table from the input/output unit 401. The storage unit 402 also stores time-date information received from the mobile terminal 30, according to an instruction from the control unit 404.

The secure storage unit 403 is a secure area that data can be written to and read from only when authentication by the authentication unit 405 is successful.

The secure storage unit 403 stores the prescription information and non-prescription drug history information. Furthermore, when prescription data is input from the hospital terminal via the input/output unit 401, the secure storage unit 403 adds the prescription data to the prescription information, in association with time-date information from the control unit 404.

In addition, on receiving a “taken drug number” and a “taken date” from the mobile terminal 30, the secure storage unit 403 adds these to the non-prescription drug history information. The taken drug number is an item identification number of a non-prescription drug that the patient has taken, and the taken date is the date on which the non-prescription drug was taken.

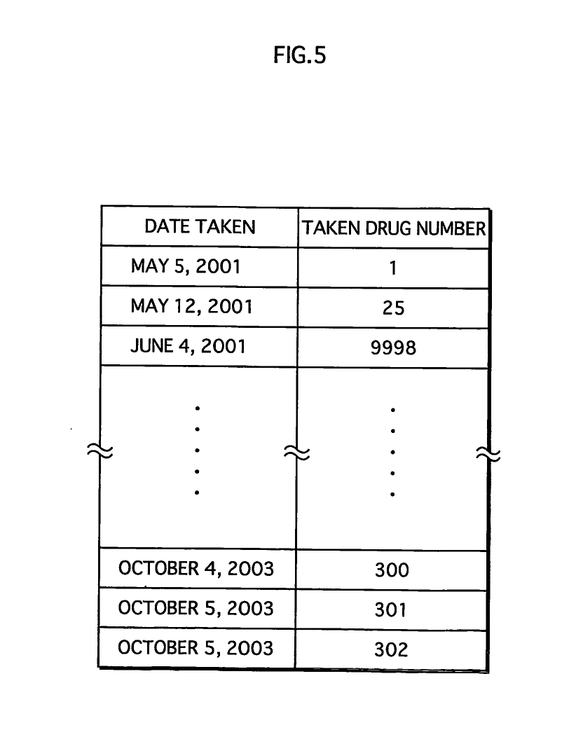

FIG. 5 shows an example of the non-prescription drug history table stored by the secure storage unit 403.

The authentication unit 405 performs authentication processing with the pharmacy server 20, according to an instruction from the control unit 404. The authentication unit 405 stores, in advance, a card ID showing the memory card 40 and a corresponding password. These are for transmitting to the pharmacy server 20.

Furthermore, the authentication unit 405 performs authentication processing, via the input/output unit 401, with the hospital terminal 50 that performs reading and writing of the confidential prescription information.

The authentication unit 405 stores, in advance, terminal authentication identification ID information and a corresponding terminal authentication password. These are for identifying the pharmacy server 20.

The authentication unit 405 transmits the ID showing the memory card 40, and the corresponding password, to the pharmacy server 20 via the mobile terminal 30.

The authentication unit 405 performs authentication with the hospital terminal 50, and transmits the authentication result to the control unit 404.

The authentication processing that the authentication unit 405 performs with the pharmacy server 20 and the hospital terminal 50 may be a simple authentication method that uses a user ID and a password, or may be another method such as one time password authentication or challenge-response authentication.

Authentication methods are described in numerous documents, including “Zukai Zatsugaku: Ango Riron (Illustrated Trivia: Encryption Theory)” written by ITO Tadashi and published by Natsume-sha, and therefore a description thereof is omitted here.

The encryption/decryption unit 406 encrypts and decrypts data, according to an instruction from the control unit 405.

Although the encryption and decryption of data is performed using a shared key cryptography method in the present example, the method is not limited to a shared key cryptography method. One alternative method is a public key cryptography method.

The encryption/decryption unit 406 shares a pharmacy shared key in advance with the pharmacy server 20, and encrypts data to be transmitted to the pharmacy server 20. Furthermore, the encryption/decryption unit 406 shares a terminal shared key in advance with the hospital terminal 20, and decrypts encrypted prescription data received from the hospital terminal 50.

The input/output buffer 407 temporarily stores data that is to be transmitted, or that has been received, by the input/output unit 401.

The control unit 404 receives data reception notification from the input/output unit 401, and sorts the data held in the input/output buffer 407 to the processing units.

When the received data includes the mutual effect table and the time-date information, the control unit 404 stores the mutual effect table and the time-date information in the storage unit 402. When the received data is encrypted prescription information, the control unit 404 instructs the encryption/decryption unit 406 to decrypt.

Furthermore, the control unit 404 instructs writing and reading of the prescription data to and from the secure storage unit 403, and instructs the authentication unit 405 to perform authentication processing with the pharmacy server 20 and the hospital terminal 50.

On receiving a check instruction for checking mutual effects of a non-prescription drug before the patient takes the drug, the control unit 404 judges whether there is a mutual effect between the non-prescription drug and any drugs prescribed at the hospital. The control unit 404 performs this judgment by reading the time-date information from the storage unit 402, and making the judgment based on the time-date information, the prescription information stored in the secure storage unit 403, and the mutual effect table stored in the storage unit 402. The control unit 404 then transmits a judgment result to the mobile terminal 30.

The control unit 404 has the secure storage unit 403 store, as the non-prescription drug history table, the time-date information and the item identification number of the non-prescription drug that the patient has decided to take.

1.2.5. Hospital Terminal 50

The hospital terminal 50 is, specifically, a computer system that includes a microprocessor, a ROM, a RAM, a display unit, a hard disk, a keyboard, a card reader, and the like. Computer programs are loaded into the RAM, and the hospital terminal 50 achieves its functions by the microprocessor operating according to the computer programs.

The card reader performs input and output of data with the memory card 40, when the memory card 40 is inserted therein.

The hospital terminal 50 performs authentication processing with the authentication unit 405.

The authentication unit 405 stores hospital terminal ID information identifying the hospital terminal, and a corresponding terminal password.

When the hospital terminal receives authentication result information indicating normal authentication from the memory card 40, the hospital terminal 50 encrypts the prescription data, and transmits a prescription data write instruction, that includes the encrypted prescription data, to the memory card 40. The hospital terminal 50 does not transmit a prescription data write instruction when the authentication result information indicates abnormal authentication.

In the present example, the hospital terminal 50 shares a terminal shared key with the encryption/decryption unit 406 in advance, and uses the terminal shared key in encryption and decryption of data to and from the memory card 40.

1.3 Operations

The following describes the actual operations of the medication history management system 1.

1.3.1 Obtaining and Storing the Present Time in the Memory Card

The memory card 40 does not have a clock or the like because it operates with power supplied from the mobile terminal 30. For this reason, the memory card 40 obtains time information accurate to the hour from the mobile terminal, and uses the obtained time information in various processing.

The clock unit 306 counts time, and transmits timer notification to the control unit 305 each hour.

The control unit 305 reads the time-date information from the time-date register of the clock unit 306, and transmits time-date notification information that includes the time-date information to the memory card 40 via the card input/output unit 304.

The input/output unit 401 receives the time-date notification information, stores the time-date information in the input/output buffer 407, and transmits data reception notification to the control unit 404.

The control unit 404 checks the header of the data stored in the input/output buffer 407, identifies the data as being time-date information, and stores the time-date information in the storage unit 402.

According to the stated procedure, the memory card 40 updates the time-date information every hour, and has the updated time-date information stored in the storage unit 402.

1.3.2 Processing for the Memory Card 40 to Receive Prescription Data From the Hospital Terminal 50 and Update Prescription Information

When feeling unwell, or when ill, the patient visits the hospital at which the hospital terminal 50 is located, and is examined by a doctor at the hospital.

The patient hands the memory card 40 to the doctor, and the doctor inserts the memory card 40 in the card reader of the hospital terminal 50.

After examining the patient, the doctor writes a prescription for the patient, and, by operating the hospital terminal 50, also creates prescription data that is electronic data of the prescription.

Before the prescription data is written to the memory card 40, the hospital terminal 50 and the authentication unit 405 of the memory card 40 perform authentication processing.

The hospital terminal 50 transmits a prescription data write request, hospital terminal ID information, and a corresponding password to the memory card 40.

The input/output unit 401 receives the prescription data write request, the hospital terminal ID information, and the corresponding password, and writes them temporarily to the input/output buffer 407. The input/output unit 401 then transmits data reception notification information to the control unit 404.

The control unit 404 checks the header of the data in the input/output buffer 407, recognizes that the data is a prescription data write request, and instructs the authentication unit 405 to read the data from the input/output buffer 407.

The authentication unit 405 judges whether the hospital terminal ID information and the corresponding password, which are the data in the input/output buffer 407, match the set of the terminal authentication information and terminal password which are stored in advance. The authentication unit 405 transmits authentication result information indicating normal authentication to the control unit 404 when the two sets match, and transmits authentication result information indicating abnormal authentication to the control unit 404 when the two sets do not match.

The control unit 404 transmits the authentication result information to the hospital terminal 50 via the input/output unit 401.

When the authentication result information indicates normal authentication, the hospital terminal 50 transmits prescription data write permission information via the input/output unit 401. When the result information indicates abnormal authentication, the hospital terminal 50 transmits prescription data write denial information via the input/output unit 401.

When the authentication result information received from the memory card 40 indicates normal authentication, the hospital terminal 50 encrypts the prescription data with the terminal shared key, and transmits a prescription data write instruction that includes the encrypted prescription data to the memory card 40.

The memory card 40 receives the encrypted prescription data from the hospital terminal 50 via the input/output unit 401, and stores the encrypted prescription data temporarily in the input/output buffer 407.

The input/output unit 401 transmits data reception notification to the control unit 404.

The control unit 404 checks the header of the data stored in the input/output buffer 407, identifies the data as being a prescription data write instruction, and instructs the encryption/decryption unit 406 to decrypt the encrypted prescription data in the input/output buffer 407.

The encryption/decryption unit 406 decrypts the encrypted prescription information using the terminal shared key, which is shared in advance with the hospital terminal 50.

The control unit 404 adds the prescription data to the prescription information stored in the secure storage unit 403.

The doctor removes the memory card 40 from the hospital terminal 50, and returns the memory card 40 to the patient.

1.3.3 Purchase Order Processing Performed by the Patient Before Going to the Pharmacy

The patient performs purchase order processing before going to purchase a drug corresponding to the prescription data at his/her usual pharmacy at which the pharmacy server 20 is located.

The patient inserts the memory card 40 into the mobile terminal 30. The memory card 40 has stored thereon the prescription data created by the doctor.

The patient inputs a purchase order instruction using a purchase order key that is part of the keypad of the mobile terminal 30.

The control unit 305 receives the purchase order instruction, and instructs the communication unit 303 to establish communication with the pharmacy server 20.

The communication unit 303 establishes a communication path with the pharmacy server 20 according to the instruction from the communication unit 305.

The control unit 305 transmits the purchase order instruction to the memory card 40 via the card input/output unit 304.

The memory card 40 stores the purchase order instruction to the input/output buffer 407 via the input/output unit 401, and the input/output unit 401 transmits data reception notification to the control unit 404.

The control unit 404 checks the header of the data stored in the input/output buffer 407, and identifies the data as being a purchase order instruction. The control unit 404 then instructs the authentication unit 405 to perform authentication processing with the pharmacy server 20.

The authentication unit 405 transmits a card authentication request to the pharmacy server 20 via the mobile terminal 30. The card authentication request includes the pre-stored card ID showing the memory card 40 and an encrypted password that is the corresponding password encrypted with the pharmacy shared key.

The pharmacy server 20 judges whether the set of the ID and password received from the mobile terminal 30 match the stored set of the pharmacy card ID and pharmacy password. The pharmacy server 20 transmits a card authentication result showing normal authentication to the memory card 40 via the mobile terminal 30 when the two sets match, and transmits a card authentication result showing abnormal authentication to the memory card 40 via the mobile terminal 30 when the two sets do not match.

In the memory card 40, the control unit 404 receives the card authentication result via the input/output unit 401 and the input/output buffer 407.

When the card authentication result shows normal authentication, the control unit 404 instructs the encryption/decryption unit 406 to encrypt un-transmitted prescription data from among the prescription information stored in the secure storage unit 403.

The encryption/decryption unit 406 reads the un-transmitted prescription data from the secure storage unit 403, encrypts the prescription data using the pharmacy shared key, and outputs the encrypted prescription data to the pharmacy server 20 via the input/output unit 401 and the mobile terminal 30.

Note that the secure storage unit 403 stores, in correspondence with each piece of prescription data, data indicating whether or not the piece of prescription data has been transmitted.

The pharmacy server 20 decrypts the received encrypted prescription data using the pharmacy shared key.

The pharmacy server 20 transmits total wait time information to the mobile terminal 30. The total wait time information is the time indicated by the stored work wait time information added to the time indicated by the stored preparation time information for the drug identified by the item ID number in the prescription data.

The mobile terminal 30 displays the received total wait time information on the display unit 301.

As one example, the total wait time information is information indicating “two hours”, and the display unit 301 displays a message such as “prescription wait time: two hours”.

The patient is able to purchase the drug based on the prescription data without waiting if he/she goes to the pharmacy two hours or more after making the purchase order.

1.3.4 Mutual Effect Table Updating Processing in the Memory Card 40

When the mutual effect table is updated, the pharmaceutical company server 10 transmits a mutual effect table update instruction that includes the mutual effect table to the mobile terminal 30.

The mobile terminal 30 receives the mutual effect table update instruction in the communication unit 303, and transmits the mutual effect table instruction to the input/output unit 401 of the memory card 40 via the card input/output unit 304.

The input/output unit 401 stores the mutual effect table temporarily in the input/output buffer 407, and transmits data reception notification to the control unit 404.

The control unit 404 checks the header of the data stored in the input/output unit buffer 407, judges that the data is a mutual effect table update instruction, and has the storage unit 402 store the mutual effect table that is included in the mutual effect table update instruction.

The storage unit 402 destroys the old mutual effect table, consequently storing only the latest mutual effect table.

1.3.5 Processing for Checking for a Mutual Effect

Before purchasing a drug, such as non-prescription cold medication, at a shop such as a pharmacy or a convenience store, the patient checks whether the drug to be purchased has any mutual effects with prescription drugs which the patient is presently being prescribed.

The patient inputs a mutual effect table start instruction by operating a mutual effect table check start key that is part of the keypad 302 of the mobile terminal 30.

The control unit 305 receives the mutual effect check start instruction, and instructs the display unit 301 to display a check-target selection screen. The display unit 301 displays the check-target selection screen.

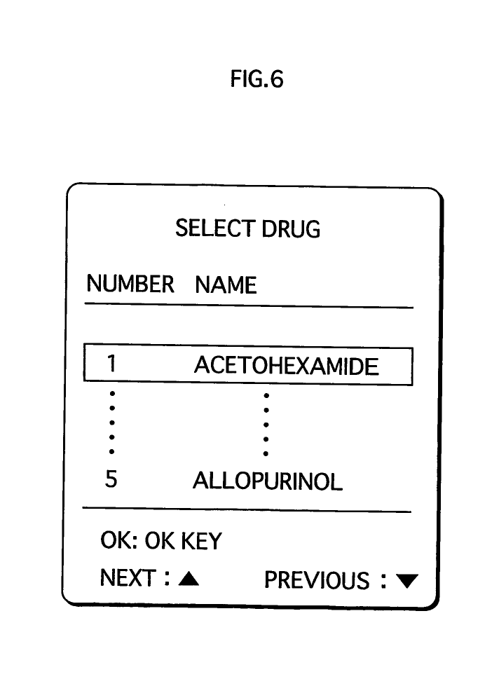

FIG. 6 shows an example of the check-target selection screen.

The patient operates the keypad 302 to find the name of the drug that he/she is considering purchasing from among drug names displayed on the display 301, and inputs the product number corresponding to the drug. The patient then operates a mutual effect check execution key that is part of the keypad 302.

The product numbers are in one-to-one correspondence with the item ID numbers, and a table showing this correspondence is held by the control unit 305.

As an alternative to inputting the product number, the product name may be selected from a list of product names displayed on the screen of the mobile terminal by operating an OK key.

The keypad 302 transmits a mutual effect check execution instruction corresponding to the mutual effect check execution key to the control unit 305. The mutual effect check execution instruction includes the item ID number corresponding to the product number.

On receiving a mutual effect check execution instruction from the keypad 302, the control unit 305 transmits a check execution instruction to the memory card 40. The check execution instruction includes a check-target ID number that is the item ID number corresponding to the product number.

The control unit 404 receives the check execution instruction via the input/output unit 401 and the input/output buffer 407. The control unit 404 then reads the time- date information from the storage unit 402, and obtains the time-date indicated by the time-date information and prescription data corresponding to a drug taken on the same date.

The control unit 404 judges that a drug is being taken on the date when the time-date information shows a time-date that falls on or between the prescription date and a date obtained by adding the prescription days minus one to the prescription date. As one example, if the prescription date shows “Oct. 5, 2003”, the prescription days shows “3”, and the item ID number is “2”, the prescription data will be considered to be “same-date prescription data” that is subject to a mutual effect check if the time-date information shows either “Oct. 5, 2003”, “Oct. 6, 2003”, or “Oct. 7, 2003”.

The control unit 404 judges whether the set of the item ID number of the same-date prescription data and the check-target ID number matches any of the mutual effect combinations in the mutual effect table stored in the storage unit 402.

When the set is judged match a mutual effect combination, the control unit 404 transmits a symptom display instruction to the mobile terminal via the input/output unit 401. In this case, the symptom display instruction includes a symptom ID number corresponding to the matching combination. When the set is judged not to match any of the mutual effect combinations, in other words, when there is no mutual effect, the control unit 404 transmits a symptom display instruction that includes a symptom ID number with a value “0” to the mobile terminal 30 via the input/output unit 401.

The input/output unit 304 of the mobile terminal 30 receives the symptom display instruction, and notifies the control unit 305.

The control unit 305 instructs the display unit 301 to display a message corresponding to the value of the symptom ID number in the symptom display instruction. If, for example, the value of the symptom ID number is “1”, the display unit 301 displays a message such as “mutual effect: increase of insulin in the blood” to alert the patient to the fact that there is a mutual effect. If the value of the symptom ID number is “0”, the display unit 301 displays a message such as “no mutual effect”.

Although the judgment for mutual effects is described as being made using the combination of input from the mobile terminal 30 and the item ID number in the prescription data, the judgment may instead be made in another way. One possible alternative is to judge whether there is a mutual effect based on the item ID number showing a drug taken on the same date in the non-prescription drug history table, and mutual effect combination information in the mutual effect table.

A further alternative is to judge that there is a mutual effect when a mutual effect is judged to exist in at least one of the method that uses the prescription data and the method that uses the non-prescription drug history table.

After displaying the message corresponding to the symptom ID number, the control unit 30 5 has the display unit 301 display a message prompting the patient to select whether he/she will take the non-prescription drug, and input a selection result.

The patient decides whether or not to take the non-prescription drug, and, following the display, makes an input indicating his/her decision using the keypad 302. As one example, the patient presses a “1” key in the ten-key pad showing to indicate that he/she will take the non-prescription drug, or presses a “0” key in the ten-key pad to indicate that he/she will not take the non-prescription drug.

When input indicating that the patient will take the non-prescription drug is received, the control unit 305 transmits a record instruction to the control unit 404 via the input/output unit 401 and the input/output buffer 407. The record instruction includes the item ID number.

The control unit 404 reads the time-date information from the storage unit 402, and adds the item ID number in association with the time-date information to the non-prescription drug history table stored in the secure storage unit 403.

1.4 Modifications

Although the present invention has been described based on the above first embodiment, the present invention is not limited to the preferred embodiment. Cases such as the following are included in the present invention.

(1) Although the an example of a judging for mutual effects of drugs is described above, a judgment may be made for mutual effects of a drug and a consumable other than a drug, for example between the drug “acetohexamide” and the fruit “grapefruit”.

(2) Although mutual effects are judged for between drugs, mutual effects may instead be judged for between ingredients contained in drugs. In such as case, the mutual effect combination information in the mutual effect table includes ingredient ID numbers instead of ID numbers of drugs.

(3) The medication history management apparatus may have the following structure.

After taking a non-prescription drug, the patient uses the keypad 302 to input into the mobile terminal 30 a drug number of the taken non-prescription drug and effect information. The effect information indicates whether the non-prescription drug had an effect such as improving the patient's symptom.

The mobile terminal 30 receives the drug number and the effect information, and transmits the received drug number and effect information to the memory card 40. The memory card 40 receives the drug number and the effect information, searches for a drug number identical to the received drug number from the non-prescription drug history table, and stores the received effect information in correspondence with the found drug number in the non-prescription drug history table. When the patient next considers purchasing the same non-prescription drug, he/she inputs the item ID number indicating the non-prescription drug into the mobile terminal 30 using the keypad 302. The mobile terminal 30 transmits the item number to the memory card 40, and the memory card 40 obtains the item ID number.

When the memory card 40 has obtained, via the mobile terminal 30, the item ID number indicating the non-prescription drug that the patient is considering purchasing, the memory card 40 reads, from the non-prescription drug history table, the effect information corresponding to the drug number that matches the item ID number, and outputs the read effect information to the mobile terminal 30. The mobile terminal 30 receives the effect information, and displays the received effect information in correspondence with the item ID number. This enables the patient to know whether the non-prescription drug that he/she is considering purchasing was effective in improving the symptom in the past.

The following is a further possible structure.

When the patient has taken an effective non-prescription drug, the patient uses the keypad 302 to input a drug number showing the non-prescription drug, and a symptom ID number identifying the symptom for which the non-prescription drug was effective.

The mobile terminal 30 receives the drug number and the symptom ID number, and transmits the received drug number and symptom ID number to the memory card 40. The memory card 40 receives the drug number and the symptom ID number, searches a drug number identical to the received drug number from the non-prescription drug history table, and stores the received symptom ID information in correspondence with the found drug number included in the non-prescription drug history table.

When the patient next considers purchasing a non-prescription drug, he/she inputs an improvement symptom number indicating the symptom that he/she wishes to improve by taking the non-prescription drug, into the mobile terminal 30 using the keypad 302. The mobile terminal 30 transmits the improvement symptom number to the memory card 40, and the memory card 40 obtains the improvement symptom number.

When the memory card 40 has obtained, via the mobile terminal 30, the improvement symptom number of the symptom to be improved, the memory card 40 reads, from the non-prescription drug history table, the drug number corresponding to the symptom ID number, and outputs the read drug number to the mobile terminal 30. The mobile terminal 30 receives the drug number, and displays the received drug number in correspondence with the product number and product name of corresponding to the received drug number.

Accordingly, when considering purchasing a non-prescription drug, the patient is able to know which non-prescription drug was effective in improving the patient's symptom in the past.

(4) The medication history management apparatus may have the following structure.

When the patient experiences an allergic reaction from a drug, the patient uses the keypad 302 to input an item ID number identifying the drug, and allergy information indicating that an allergic reaction was experienced. The mobile terminal 30 receives the item ID number and the allergy information, and transmits the received item ID number and allergy information to the memory card 40. The memory card 40 obtains the item ID number and the allergy information, and stores the obtained item ID number and allergy information in correspondence.

When the patient next considers purchasing a non-prescription drug, he/she inputs an item ID number indicating the non-prescription drug that he/she is considering purchasing, into the mobile terminal 30 using the keypad 302. The mobile terminal 30 transmits the item ID number to the memory card 40, and the memory card 40 obtains the item ID number. Next, the memory card 40 retrieves additional information that is stored in correspondence with a non-prescription drug number that is identical to the obtained item ID number. The memory card 40 judges whether the retrieved additional information indicates that an allergic reaction was experienced, and if so, outputs the drug number and the allergy information to the mobile terminal 30. The mobile terminal 30 receives the drug number and the allergy information, and displays the drug number and the allergy information.

This enables the patient to know whether or not a non-prescription drug that he/she is considering purchasing may cause an allergic reaction, before taking the drug.

(5) It is unnecessary for the whole mutual effect table to be stored in the memory card 40. Instead a structure in which the memory card 40 makes requests to the pharmaceutical company server 10 or the like as necessary is possible.

Instead of storing the whole mutual effect table, the memory card 40 may make a request to the pharmaceutical company server 10 each time the mutual effect table is to be used. Alternatively, the memory card 40 may store part of the mutual effect table, and the pharmaceutical company server 10 may store the remaining part of the mutual effect table. The memory card 40 may request the remaining part via the mobile terminal 30 from the pharmaceutical company server 10 when necessary.

As a further alternative, the memory card 40 may store part of the mutual effect table, and when a required part of the mutual effect table is not included in the stored part, request the required part via the mobile terminal 30, and store the obtained part additionally as part of the already-stored mutual effect table.

(6) The medical history management apparatus may have a further function of performing management of effect remain time.

In this case, a timer is provided in the control unit 404 of the memory card 40. This timer measures time.

Here, when the memory card 40 is inserted in the card slot (not illustrated) of the mobile terminal 30, the control unit 305 reads time-date information, which indicates the present time and date, from the clock unit 306, and transmits the read time-date information to the memory card 40.

The control unit 404 receives the time-date information from the mobile terminal 30 via the input/output-unit 401, and sets the timer to the present time.

Note that it is unnecessary to transmit the time-date if the memory card 40 has a structure in which it provides its own power.

Furthermore, although the non-prescription drug history information stored by the secure storage unit 403 is described as including being composed of drug numbers, which are item numbers of non-prescription drugs and the like taken by the patient, in correspondence with taken time-dates, in the present modification, the non-prescription drug history information is composed of drug numbers which are item ID numbers of non-prescription drugs and prescription drugs, taken time-dates, and elapsed times, in correspondence.

Each elapsed time indicates how much time has elapsed since taking the drug of the corresponding drug number.

The following describes a case in which the memory card 40 performs processing to check for a physical effect caused by a combination of drugs.

The patient checks for physical effects caused by a combination of a drug, such as cold medicine to be purchased at a retail establishment, and a drug that has already been taken.

The patient presses a check start key that is part of the keypad 302 of the mobile terminal.

The control unit 305 receives check start information from the keypad 302, and instructs the display unit 301 to display the check-target selection screen. The display unit 301 displays the check target selection screen.

The patient operates a cursor key that is part of the keypad 302, to align the cursor on the product number and the product name of the product he/she is considering purchasing, and presses an OK key that is part of the keypad 302.

The product number and product name are in one-to-one correspondence with the item ID numbers, and the control unit 305 stores a correspondence table showing this correspondence.

The control unit 305 transmits a check execution instruction to the memory card 40 via the card input/output unit 304. The check execution instruction includes a check target ID number that is the item ID number corresponding to the selected product number.

The control unit 404 receives the check execution instruction via the input/output unit 401 and the input/output buffer 407. The control unit 404 judges whether or not the drug number corresponding to the check target ID number is in the non-prescription drug history information, and instructs the input/output unit 401 to transmit a judgment result that shows “duplicate administration” when the drug number is in the non-prescription drug history information, and “to duplicate administration” when the drug number is not in the non-prescription drug history information. The input/output unit 401 outputs the judgment result to the mobile terminal 30.

The control unit 305 receives the judgment result via the card input/output unit 304, and has the display unit 301 display the judgment result.

Furthermore, the control unit 305 searches the mutual effect table for mutual effect combination information that matches a set of the item ID number and any of the drug numbers in the non-prescription drug history information.

When there is matching mutual effect combination information, the control unit 404 transmits a symptom display instruction which includes the symptom ID number corresponding to the matching mutual effect combination information, to the mobile terminal 30 via the input/output unit 401. When there is no matching mutual effect combination information, the control unit 404 transmits a symptom display instruction which includes a symptom ID number “0”, to the mobile terminal 30 via the input/output unit 401.

The card input/output unit 304 of the mobile terminal 30 receives the symptom display instruction, and notifies the control unit 305.

The control unit 305 instructs the display unit 301 to display a message corresponding to the value of the symptom ID number in the symptom display instruction. For example, if the symptom ID number is “1”, the display unit 305 displays a message such as “mutual effect: increase of insulin in the blood”, to show the patient that there is a mutual effect, and prompt the patient to be cautious. If the symptom ID number is “0”, the display unit 305 displays a message such as “no mutual effect”.

After the message corresponding to the symptom number is displayed, the control unit 305 has the display unit 301 perform display that prompts the patient to input whether he/she will take the drug. The patient determines whether he/she will take the drug, and inputs the result of his/her decision with use of the keypad 302 following the display that prompts input. For example, the patient presses the “1” key in the ten keypad if he/she will take the drug, and presses the “0” key in the ten keypad if he/she will not take the drug.

The control unit 305 notifies the control unit 404, via the card input/output unit 304 and the input/output unit 401, of a selection result that indicates whether the patient will take the drug.

When the selection result indicates that the patient will take the drug, the control unit 404 obtains the present time from the timer, and makes in entry in the non-prescription drug history information in the secure storage unit 403. In this entry, the obtained present time is used as the taken time-date, the item ID number as the taken drug number, and the value of the elapsed time is “0”.

Here, the input indicating the decision to take the drug may instead be made by the patient operating the keypad 302 to make an input of a drug number identifying a drug that has been taken, and input indicating completion of taking of the drug. In this case, the control unit 305 notifies the control unit 404 of the taken drug number and completion of taking of the drug.

Furthermore, the control unit 404 updates the elapsed time in the non-prescription drug history information each time it recognizes that a predetermined amount of time, for example ten minutes, has elapsed, according to the timer.

When updating, the control unit 404 reads the present time from the timer, calculates the difference between the present time and the taken time-date in correspondence with the elapsed time that is to be rewritten, and rewrites the elapsed time with the calculated difference. As one example, if the present time-date measured by the timer is “16:30, Oct. 5, 2003”, and the taken time-date corresponding to the elapsed time to be rewritten is “16:10, Oct. 4, 2003”, the control unit 404 calculates the difference between the present time and the taken time-date, and overwrites the elapsed time with the calculation result which is “24 hours, 20 minutes”.

Furthermore, if the apparatus has ample timer resources, a plurality of timers may be used to measure elapsed time. One timer may be provided per entry of elapsed time that is an update target in the non-prescription drug history information. Alternatively, one timer may be provided per plurality of entries.

Here, the control unit 404 stores a list of sets that each include a taken drug number and a effect remain time of the drug corresponding to the taken drug number. In the updating processing, when the elapsed time, which is the difference between the calculated present time and the taken time-date, for a particular taken drug number is greater than the effect remain time of the corresponding taken drug number, the control unit 404 deletes, from the non-prescription drug history information, the set of the taken time-date, the taken drug number and the elapsed time that are the entry for the corresponding taken drug number.

The effect remain time is an amount of time that a physical effect of the a drug corresponding to the taken drug number is expected to last in the patient.

(7) Furthermore, when reading/writing data from/to the secure storage unit 403, the control unit 305 may perform authentication processing with the authentication unit 405. Here, the authentication method is as described earlier. Only when the authentication is successful is the control unit 305 able to read/write data from/to the secure storage unit 403 via the control unit 404 and the like.

(8) The non-prescription drug history information is not limited to being input by the patient, but may be downloaded from an external server apparatus.

Whichever of the pharmaceutical company server 10 and the pharmacy server 20 is the external server apparatus makes a request to the control unit 305, via the communication unit 303 of the mobile terminal 30, to write non-prescription drug history drug information to the secure storage unit 403.

The control unit 305 makes a request to the control unit 404, via the card input/output unit 304 and the input/output unit 401, to write the non-prescription drug history information to the secure storage unit 403, and the control unit 404 writes the non-prescription drug history drug information to the secure storage unit 403.

Note that it is possible to have a structure in which, in the processing for writing the non-prescription drug history drug information to the secure storage unit 403, authentication processing is performed between the authentication unit 405 of the memory card 40 and the external server, the control unit 404 writes to the secure storage unit 403 only when the authentication processing is successful.

Similarly, when the memory card 40 is inserted in the hospital terminal 50, the hospital terminal 50 makes a request to the control unit 404 of the memory card to write non-prescription drug information stored in the hospital terminal 50, and the control unit 404 writes the non-prescription drug information to the secure storage unit 403.

Note that it is possible to have a structure in which, in the processing for writing the non-prescription drug history drug information to the secure storage unit 403, authentication processing is performed between the authentication unit 405 of the memory card 40 and the hospital terminal 50, and the control unit 404 writes to the secure storage unit 403 only when the authentication processing is successful.

(9) The present invention may be methods shown by the above. Furthermore, the methods may be a computer program realized by a computer, and may be a digital signal of the computer program.

Furthermore, the present invention may be a computer-readable recording medium such as a flexible disk, a hard disk, a CD-ROM (compact disc-read only memory), and MO (magneto-optical), a DVD-ROM (digital versatile disc-read only memory), a DVD-RAM (digital versatile disc-random access memory), a BD (Blu-Ray Disc) or a semiconductor memory, that stores the computer program or the digital signal. Furthermore, the present invention may be the computer program or the digital signal recorded on any of the aforementioned recording medium apparatuses.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium apparatus, or by transferring the program or the digital signal over a network or the like, the program or the digital signal may be executed by another independent computer system.

(7) The present invention may be any combination of the above-described embodiments and modifications.

### Second Embodiment

2. Skin Diagnosis System

2.1 Overview

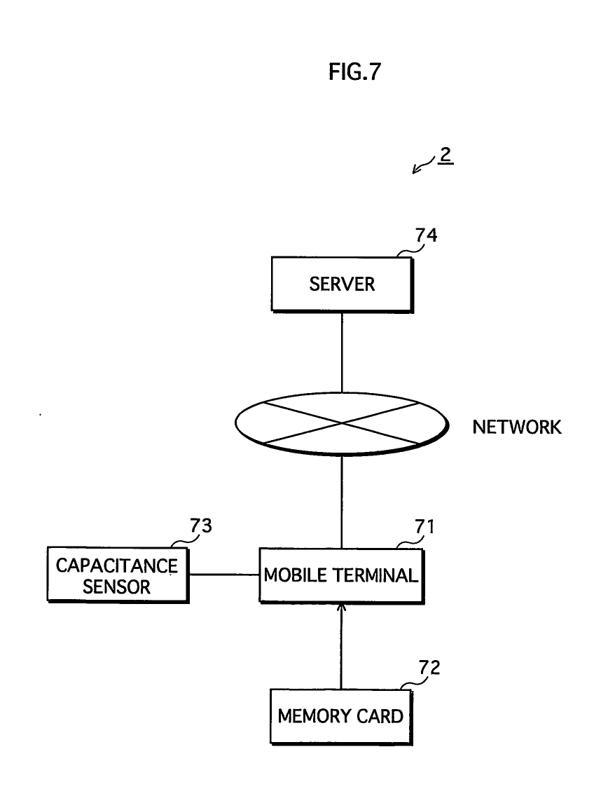

FIG. 7 is a schematic diagram of a skin diagnosis system 2.

The skin diagnosis system 2 measures the amount of moisture in a user's skin, and notifies the user of the condition of his/her skin.

A mobile terminal 71 is a terminal such as a PDA that includes a liquid crystal display, a keypad, and a card slot. The mobile terminal 71 has a wireless communication function and connects to a network via a wireless relay station (not illustrated).

The mobile terminal 71 performs transmission and reception with a memory card 72 when the memory card 72 in inserted in the card slot.

A capacitance sensor 73 measures capacitance between two electrodes that are part thereof, and is connected to the mobile terminal 71.

The user, who possesses the mobile terminal 71, presses the capacitance sensor 73 against the part of the skin that he/she wishes to measure, and presses a measuring start switch of the capacitance sensor 73.

On detecting the measuring start switch being pressed, the capacitance sensor 73 measures capacitance between the electrodes.

Capacitance varies depending on the amount of moisture in the skin. Specifically, the drier the skin is, the lower the capacitance value.

The capacitance sensor 73 transmits the measured capacitance to the memory card 72 via the mobile terminal 71.

The memory card 72 has two types of storage areas: a normal storage area, and a secure storage area. A moisture amount judgment table and a skin level table are stored in the normal storage area.

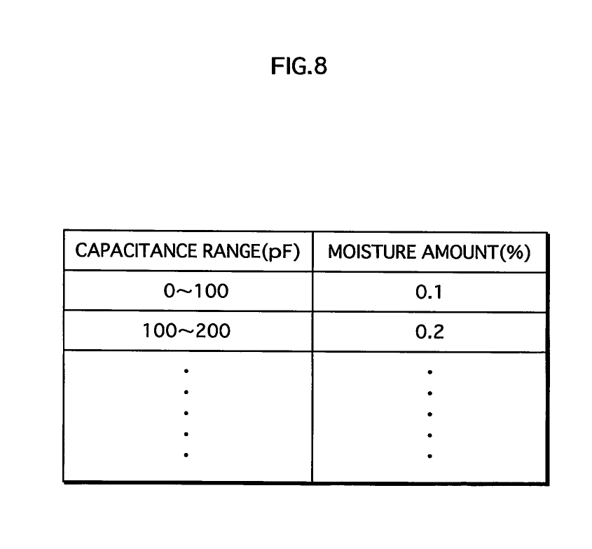

FIG. 8 shows the moisture amount judgment table stored in the memory card 72.

The moisture amount judgment table shows capacitance ranges that are each made up of an upper limit and a lower limit of capacitance, and corresponding moisture amounts. As one example in FIG. 8, the corresponding moisture amount is 0.2% when the capacitance measured by the capacitance sensor 73 is at least 100 picofarads and less than 200 picofarads.

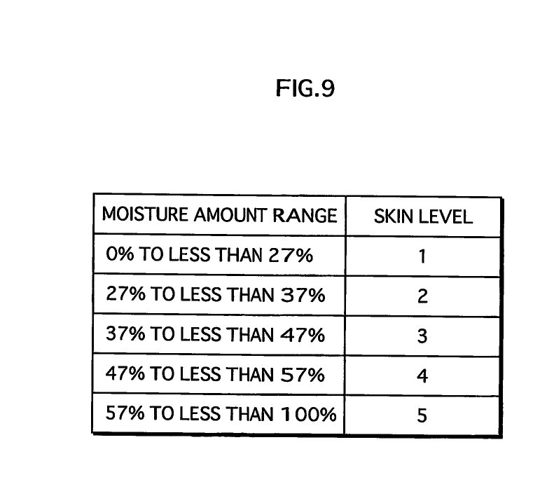

FIG. 9 shows the skin level table stored in the memory card 72.

The skin level table is a guide determined by the manufacturer of the capacitance sensor 73, and is divided into levels one through to five according to moisture amount. The skin level table shows moisture ranges that are each made up of an upper limit and a lower limit, and corresponding skin levels.

The memory card 72 determines the skin level corresponding to the capacitance received from the capacitance sensor 73 using the moisture amount judgment table based on the received capacitance. The memory card 72 then transmits the determined skin level to the mobile terminal 71, and the mobile terminal 71 displays the skin level on a display unit. Furthermore, the memory card 72 stores the skin level in the secure area as skin condition history information.

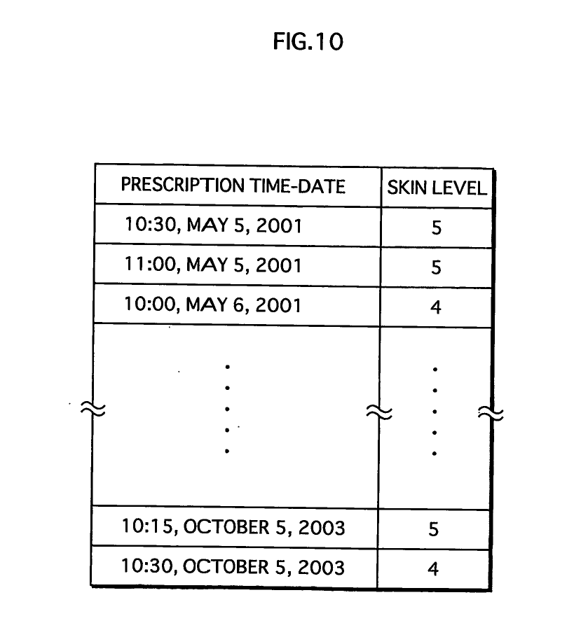

FIG. 10 shows the skin condition history information.

The skin condition history information is composed of measurement time-dates and skin level information, each measurement time-date showing a time and date on which the user's skin was diagnosed, and each piece of skin level information showing the skin level determined according to the measurement.

2.2 Structure

2.2.1 Mobile Terminal 71

The mobile terminal 71 is, specifically, a PDA or the like that includes a ROM, a RAM, a display, and a keyboard. The mobile terminal 71 achieves its functions by the microprocessor operating according to computer programs that are loaded into the RAM.

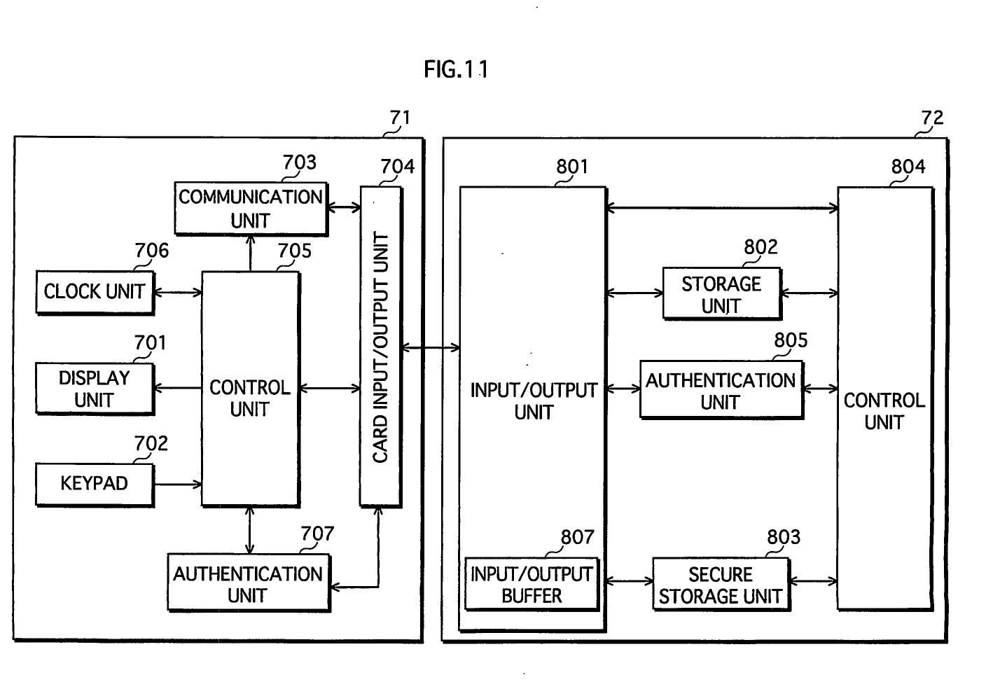

FIG. 11 is a block diagram showing the internal structure of the mobile terminal 71 and the memory card 72.

The display unit 701 is a liquid crystal display, and displays according to instructions by the control unit 705.

The keypad 702 has input buttons including a ten keypad, and is used by the patient to give various instructions to the mobile terminal 71. The keypad 702 transmits key information corresponding to a pressed key to the control unit 705.

The communication unit 703 connects to the network by wireless communication via the wireless relay station (not illustrated) and the like, and communicates with a server 74.

The card input/output unit 704 connects with an input/output unit 801, and has the functions of transmitting data to and from the memory card 72 and supplying power to the memory card 72.

The clock unit 706 is a clock that has a timer and a calendar, and writes time-date information expressing a counted time to an internal time-date register. One example of the time-date information that the clock unit 706 writes to the time-date register is time-date information expressing “13:20, Oct. 5, 2003”. The clock unit 706 also has the function of giving timer notification to the control unit 705 once an hour.

On receiving timer notification from the clock unit 706, the control unit 705 reads the time-date information from the time-date register of the clock unit 706, and transmits time-date information notification that includes the time-date information to the memory card 72 via the card input/output unit 704.

The control unit 705 receives various key information from the keypad 702, and performs processing corresponding to the received key information.

2.2.2 Memory Card 72

The memory card 72 is a portable memory card that includes a microprocessor, a ROM, a RAM, and a memory that has a secure area.

The memory card 72 operates according to power supplied by the mobile terminal 71. Note that an alternative structure is one in which the memory card 72 has an internal battery, and therefore does not require power from the mobile terminal 71.

The input/output unit 801 transmits data to and receives data from the card input/output unit 704. The input/output unit 801 temporarily stores received data and data to be transmitted in the input/output buffer 807.

The transmitted and received data has a header in which is written information necessary in transmission and reception. This information includes the data type, data transmission-origin data, and data transmission-destination information.

In the case of receiving data, the input/output unit 801 stores the received data in the input/output buffer 807, and transmits data reception notification to the control unit 804. The control unit 804 checks the header of the reception data stored in the input/output buffer 807, and sorts the stored data to the storage unit 802, the control unit 804, the authentication unit 805, and the encryption/decryption unit 806.

In the case of being instructed to transmit data, the input/output unit 801 transmits the data to the card input/output unit 704 in accordance with the instruction.

The storage unit 802 includes a storage area, and, according to an instruction by the control unit 804, receives and stores the mutual effect table from the input/output unit 801. The storage unit 802 also stores time-date information received from the mobile terminal 71.

The secure storage unit 803 is a secure area that data can be written to and read from only when authentication by the authentication unit 805 is successful.

The secure storage unit 803 stores the skin condition history information. When instructed by the control unit 804, the secure storage unit 803 adds a set of a measurement date and a skin level to the skin condition history information.

The control unit 804 receives data reception notification from the input/output unit 801, and sorts the data held in the input/output buffer 807 to the processing units.

On receiving a request to read skin condition history information from the secure storage unit 803, the control unit 804 instructs the authentication unit 805 to perform authentication processing with the source of the read request.

The control unit 804 determines a skin level corresponding to capacitance measured by the capacitance sensor 73. Furthermore, the control unit 804 determines skin level improvement information that is the difference between a previously measured skin level, and that indicates how much the skin level has improved. This skin level improvement is determined based on the skin level stored in the skin condition history information. As one example, if the presently-measured skin level is “4”, and the previously-measured skin level is “3”, 4−3 is calculated to obtain skin level improvement information “+1”. On the other hand, if the presently-measured skin level is “3”, and the previously-measured skin level is “4”, 3−4 is calculated to obtain skin level improvement information “−1”.

The control unit 804 transmits the determined skin level improvement information to the mobile terminal 71, and the mobile terminal 71 displays the skin level improvement information on the display unit 701.

The authentication unit 805 performs authentication processing with a terminal from which a request has been received to read the confidential skin history from the secure area.

In order to restrict which terminals are permitted to read data from the secure area, the authentication unit 805 stores in advance one or more sets of information that each consist of permitted terminal ID information and a permitted password. Each permitted terminal ID information identifies a terminal to which permission to read is given, and the permitted password is the corresponding password.

During authentication, the terminal that transmitted the read request transmits request terminal ID information, which is information identifying the terminal, and a request password which is the password.

The authentication unit 805 judges whether the set of the request terminal ID information and request password match one of the sets of permitted terminal ID information and permitted passwords. The authentication unit 805 determines authentication to be normal when the sets match, and determines authentication to be abnormal when the sets do not match. The authentication unit 805 transmits the authentication result to the control unit 804.

The control unit 804 transmits the received authentication result to the terminal that made the read request.

The authentication processing that the authentication unit 805 performs may be a simple authentication method that uses a user ID and a password, or may be another method such as one time password authentication or challenge-response authentication.

Authentication methods are described in numerous documents, including “Zukai Zatsugaku: Ango Riron (Illustrated Trivia: Encryption Theory)” written by ITO Tadashi and published by Natsume-sha, and therefore a description thereof is omitted here.

The input/output buffer 807 temporarily stores data that is to be transmitted, or that has been received, by the input/output unit 801.

2.2.3 Capacitance sensor 73

The capacitance sensor 73 is composed of two electrodes, a capacitance measuring unit and a measuring start switch. The capacitance measuring unit measures capacitance between the two electrodes, and the measuring start switch is for instructing the start of measurement of capacitance.

Since water is highly dielectric compared to other matter, the ratio of water in a substance can be determined by measuring the dielectric constant of the other matter in the substance. The dielectric constant is measured by measuring capacitance with the capacitance measuring unit.

The user presses the two electrodes against his/her skin, and presses the measuring start switch.

On detecting that the measuring start switch has been pressed, the capacitance sensor 73 measures the capacitance between the two electrodes, and transmits the measured capacitance to the memory card 72 via the mobile terminal 71.

2.2.4 Server 74

The server 74 is, specifically, a computer system that includes a microprocessor, a ROM, a RAM, a display unit, a hard disk, a keyboard, a card reader, and the like. Computer programs are loaded into the RAM, and the server 74 achieves its functions by the microprocessor operating according to the computer programs.

The server 74 is operated by the manufacturer of the capacitance sensor 73, and provides the moisture amount judgment table and the skin level table via the network. The server 74 stores the moisture amount judgment table and the skin level table in an internal hard disk.

The moisture amount judgment table and the skin level table are updated by maintenance personnel at the manufacturer. Cases in which the moisture amount judgment table and the skin level table require updating include when the specifications of the capacitance sensor have been changed, when the correspondence between capacitance and moisture amount have been changed, and when the correspondence between moisture amount and skin level have been changed. When update operations are complete and the moisture amount judgment table and the skin level table have been updated, the server 74 transmits an information update instruction to the mobile terminal 71.

2.3 Operations

The following describes operations of the skin diagnosis system 2.

The user of the skin diagnosis system 2 possesses the mobile terminal 71.

The memory card 72 is inserted in the card slot of the mobile terminal 71, and the capacitance sensor 73 is connected to the mobile terminal 71.

The user presses the capacitance sensor 73 against the part of his/her skin that is to be diagnosed, and presses the measuring start switch of the capacitance sensor 73.

On detecting that the measuring start switch has been pressed, the capacitance sensor 73 measures the capacitance between the two electrodes. The capacitance sensor 73 transmits the measured capacitance and the measurement time-date to the memory card 72 via the mobile terminal 71.

The memory card 72 selects, from the moisture amount judgment table, a moisture amount that corresponds to the capacitance range in which the measured capacitance falls, and then selects, from the skin level table, a skin level that corresponds to the moisture amount range in which the selected moisture amount falls.

The memory card 72 finds, as skin level improvement information, the difference between the previous skin level and the measured skin level. The previous skin level is the most recent skin level among skin levels recorded in the skin condition history information. The memory card 72 then transmits the measured skin level and the skin level improvement information to the mobile terminal 71.

The mobile terminal 71 displays the received measured skin level and the received skin level improvement information on the display unit as a skin diagnosis result.

Furthermore, the memory card 72 records the set of the measurement time-date and the measured skin level, received from the mobile terminal 71 as skin condition information, additionally in the skin condition history information.

When the skin level table or the moisture amount judgment table is updated in the server 74, the server 74 transmits an information update instruction to the mobile terminal 71. Having received the information update instruction, the server 74 transmits an information obtain request to the server 74. On receiving the information obtain request, the server 74 transmits the updated skin level table or moisture amount judgment table to the memory card 72 via the mobile terminal 71. The memory card 72 stores the received skin level table or water amount judgment table.

Furthermore, on receiving a request to read the skin condition history information stored in the secure area, the memory card 72 performs terminal authentication processing with the terminal that sent the request. When the result of the terminal authentication processing is normal, the memory card 72 permits the terminal that sent the request to read the data in the secure area. When the result of the terminal authentication processing abnormal, the memory card 72 prohibits the terminal that sent the request from reading the data in the secure area.

2.4 Modifications

Although the present invention has been described based on the above embodiments, the present invention is not limited to the preferred embodiments. Cases such as the following are included in the present invention.

(1) The present invention is a health information management apparatus, comprising: a receiving unit operable to receive input information that shows condition of skin that is a judgment target; a storage unit operable to store a correspondence table that shows correspondence between a plurality of pieces of condition information and a plurality of pieces of skin health information, each piece of condition information showing a condition of skin, and each piece of skin health information being an indicator of a skin health condition; a selection unit operable to select, from the correspondence table, one piece of skin health information that corresponds the a piece of condition information that matches the input information; and an output unit operable to output the piece of skin health information selected by the selection unit.

(2) While an example is given for a skin diagnosis system, the system may instead be another kind of diagnosis system for beauty diagnosis achieved by the device that is connected to the mobile terminal 71 being a device other than the capacitance sensor 73.

Examples of such alternatives include: an skin elasticity measurement system achieved by changing the capacitance sensor 73 to a elasticity sensor; a skin texture/wrinkle diagnosis system achieved by changing the capacitance server 73 to a texture/wrinkle image analysis device; a moisture loss amount diagnosis system achieved by changing the capacitance server 73 to a device that measures loss of moisture from the skin surface; a sebum amount diagnosis system achieved by changing the capacitance server 73 to a device that measures the amount of sebum on the skin surface; a skin color measurement system achieved by changing the capacitance server 73 to a skin color measuring device; and a hair diagnosis system achieved by changing the capacitance server 73 to an aqua checker that measures moisture in the hair.

(3) The present invention may be methods shown by the above. Furthermore, the methods may be a computer program realized by a computer, and may be a digital signal of the computer program.

Furthermore, the present invention may be a computer-readable recording medium such as a flexible disk, a hard disk, a CD-ROM, and MO, a DVD-ROM, a DVD-RAM, a BD or a semiconductor memory, that stores the computer program or the digital signal. Furthermore, the present invention may be the computer program or the digital signal recorded on any of the aforementioned recording medium apparatuses.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium apparatus, or by transferring the program or the digital signal over a network or the like, the program or the digital signal may be executed by another independent computer system.

(4) The present invention may be any combination of the above-described embodiments and modifications.

### INDUSTRIAL APPLICABILITY

The medication history management apparatus and program of the present invention can be used in medical machines and the like for individuals to check for mutual effects and duplicate administration of drugs, and can be manufactured and sold by manufacturers of medial machines.

The medical history management system of the present invention can be used as the fundamental technology of a system for providing appropriate service to patients, and can be used by development companies that develop medical systems.

1. A mobile medication history management apparatus, comprising:
an obtaining unit operable to obtain identification information relating to a drug that a user of the medication history management apparatus is planning to take;
a secure storage unit operable to store, in a secure storage area therein, medication history information of a drug that the user has taken previously;
an information storage unit operable to store mutual effect information showing one or more mutual effects, each mutual effect being caused by taking of drugs in combination;
a judgment unit operable to refer to the stored mutual effect information to check whether any combinations exist therein of the drug shown by the obtained identification information and any of the previously taken drugs estimated to have a remaining physical effect in the user, in order to judge whether a mutual effect will occur due to taking the drug show by the obtained identification information and any of the previously taken drugs; and
an output unit operable to output a judgment result.

2. The mobile medication history management apparatus of claim 1, wherein
each of the drug that the user is planning to take and the one or more previously taken drugs is a one of a prescription drug and non-prescription drug.

3. The mobile medication history management apparatus of claim 2, further comprising:
a first download unit operable to download mutual effect information from an external server, and store the mutual effect information in the information storage unit.

4. The mobile medication history management apparatus of claim 3, further comprising:
a second download unit operable to download medication history information from a server that is one of a hospital server and a pharmacy server, and store the medication history information in the secure storage unit.

5. The mobile medication history management apparatus of claim 4, wherein
when the second download unit downloads the medication history information, the second download unit and the server perform mutual authentication processing, writing of the downloaded medication history information to the secure storage unit being permitted only when authentication succeeds.

6. The mobile medication history management apparatus of claim 1, further comprising:
a timer operable to count time from when each of the one or more previously taken drugs is taken; and
an effect time storage unit operable to store a physical effect remain time of each of one or more drugs, each physical effect remain time showing a length of time that the physical effect of the drug remains in the user from when the drug is taken,
wherein, when making the judgment, if the counted time of a previously taken drug in combination with the planned drug in the medication history information is less than the physical effect remain time of the previously taken drug, the judgment unit selects drug identification information of the previously taken drug as a target of comparison, and if the counted time of a previously taken drug in combination with the planned drug exceeds the physical effect remain time of the previously taken drug, the judgment unit excludes the drug identification information of the previously taken drug from being a target of comparison.

7. The mobile medication history management apparatus of claim 6, further comprising:
a completion reception unit operable to receive, from an external source, information showing that the user has taken the planned drug; and
a write unit operable to write the received information additionally in the drug identification information stored in the secure storage unit.

8. The mobile medication history management apparatus of claim 7, wherein
the completion reception unit and the timer of the judgment unit operate in synchronization such that the timer commences counting time upon receiving a completion signal.

9. The mobile medication history management apparatus of claim 8, being a mobile telephone that is equipped with a secure memory card,
wherein the completion signal is transmitted to the memory card upon a specific key of the mobile telephone being pressed.

10. The mobile medication history management apparatus of claim 1, being a mobile terminal that is equipped with a secure memory card.

11. The mobile medication history management apparatus of claim 10, wherein the mobile terminal is a mobile telephone.

12. The mobile medication history management apparatus of claim 10, wherein the memory card is detachably mounted in the mobile terminal.

13. A memory card that is used in an inserted state in a memory card slot of a mobile terminal, comprising:
an obtaining unit operable to obtain, from the mobile terminal, identification information relating to a drug that a user of the mobile terminal is planning to take;
a secure storage unit operable to store, in a secure storage area therein, medication history information of a drug that the user has taken previously;
an information storage unit operable to store mutual effect information showing one or more mutual effects, each mutual effect being caused by taking of drugs in combination;
a judgment unit operable to refer to the stored mutual effect information to check whether any combinations exist therein of the drug shown by the obtained identification information and any of the previously taken drugs estimated to have a remaining physical effect in the user, in order to judge whether a mutual effect will occur due to taking the drug show by the obtained identification information and any of the previously taken drugs; and
an output unit operable to output a judgment result to the mobile terminal.

14. A management method executed in a mobile medication history management apparatus that comprises a secure storage unit that stores, in a secure storage area therein, medication history information of one or more drugs that a user of the medication history management apparatus has taken previously, and an information storage unit that stores information showing one or more mutual effects, each mutual effect being caused by taking drugs in combination, the management method comprising:
an obtaining step of obtaining identification information relating to a drug that the user is planning to take;
a reading step of reading the medication history information from the secure storage unit;
a judgment step of referring to the stored mutual effect information to check whether any combinations exist therein of the drug shown by the obtained identification information and any of the previously taken drugs estimated to have a remaining physical effect in the user, in order to judge whether a mutual effect will occur due to taking the drug shown by the obtained identification information and any of the previously taken drugs; and
an output step of outputting a judgment result.

15. The management method of claim 14, further comprising:
a first download step of obtaining mutual effect information from an external server, and storing the mutual effect information in the information storage unit,
the first download step being performed in a routine that is separate to a processing sequence that includes the obtaining step though to the output step.

16. The management method of claim 15, further comprising:
a second download step of downloading medication history information from a server that is one of a hospital server and a pharmacy server, and updating contents of the secure storage unit with the downloaded medication history information,
the second download step being performed in a routine that is separate from the processing sequence.

17. The management method of claim 16,
wherein the second download step includes:
an authentication sub-step of, when downloading, executing an authentication sequence with the server,
access to the secure storage unit being permitted only when authentication succeeds.
